(19) United States
(12) Patent Application Publication
(10) Pub. No.: US 2007/0011877 A1
(43) Pub. Date: Jan. 18, 2007

(54) Method for fabricating cooling device

(76) Inventors: Kuo-Hsin Chen, Yonghe City (TW); Hsuen-Chih Lin, Yonghe City (TW)

Correspondence Address: HDSL, 4331 STEVENS BATTLE LANE, FAIRFAX, VA, 22033, US

(21) Appl. No.: 11/178,297

(22) Filed: Jul. 12, 2005

(51) Int. Cl. B23P 6/00

(52) U.S. Cl. 29/890.046; 29/890.032; 29/890.038

(57) ABSTRACT

A method for fabricating a cooling device. The cooling device includes a heat pipe and a plurality of thin fins. First, a through hole is formed on each thin fin. The through hole includes a surrounding wall of gradually withdrawing radius, so as to stack the thin fins together. Then, the heat pipe is tightly inserted from the surrounding wall of larger radius into the through holes of the thin fins. By applying two forces of opposite directions to the thin fins, the surrounding walls of the thin fins is sequentially embedded into and compressed onto the heat pipe. In this manner, the contact area between the thin fins is increased, while the contact between the surrounding wall of the thin fins and the heat pipe becomes tighter. A cooling device of better heat dissipating rate is thus fabricated.

### BACKGROUND OF THE INVENTION

The present invention relates generally to a method for fabricating a cooling device, and more particularly to a method that can increase the contact area of thin fins and heat pipes.

Conventionally, a cooling device includes a heat pipe and a plurality of thin fins. The heat pipe penetrates through the thin fins so as to complete the fabrication of the cooling device. Usually, a surrounding wall is formed around the through holes formed on the thin fins. The heat pipe then penetrates through the through holes. Since the thin fins are stacked together without contacting each other except at the surrounding wall, the contact area between the thin fins is thus very small, even without contact. Therefore, the heat transfer rate between the thin fins is very low. Each of the thin fins can only dissipate heat independently through the heat pipe. There is no way to balance the heat dissipation among the thin fins.

Accordingly, the inventor of the present invention realized the drawbacks in the conventional art, and developed the present invention that can overcome the drawbacks described above.

### BRIEF SUMMARY OF THE INVENTION

The present invention is to provide a method for fabricating a cooling device. The cooling device includes a heat pipe and a plurality of thin fins. By using the method of the present invention, both the contact area and the contact strength between the heat pipe and the thin fins are increased. A cooling device of better heat dissipating rate is thus fabricated.

The method for fabricating a cooling device having a heat pipe and a plurality of thin fins includes forming a through hole on each thin fin, the through hole having a surrounding wall of gradually withdrawing radius, thereby stacking the thin fins together; tightly inserting the heat pipe from the surrounding wall of larger radius into the through holes of the thin fins; and applying two forces of opposite directions to the thin fins, thereby securely contacting the surrounding walls of the thin fins to the heat pipe.

### BRIEF DESCRIPTION OF THE DRAWINGS

FIG. 1 is an exploded view illustrating the heat pipe and the thin fins of the present invention.

FIG. 2 is a partial perspective view of a thin fin of the present invention.

FIG. 3 is a partial section view of the thin fin of the present invention.

FIG. 4 illustrates a step of stacking the thin fins, according to the present invention.

FIG. 5 illustrates a step of penetrating the heat pipe through the thin fins, according to the present invention.

FIG. 6 illustrates the heat pipe being penetrated through the thin fins, according to the present invention.

FIG. 7 is an enlarged view of part A of FIG. 6.

FIG. 8 illustrates the combination of the heat pipe and the thin fins, according to the present invention.

FIG. 9 is a partial perspective view, in accordance with another aspect of the present invention.

### DETAILED DESCRIPTION OF THE INVENTION

In order to better understanding the features and technical contents of the present invention, the present invention is hereinafter described in detail by incorporating with the accompanying drawings. However, the accompanying drawings are only for the convenience of illustration and description, no limitation is intended thereto.

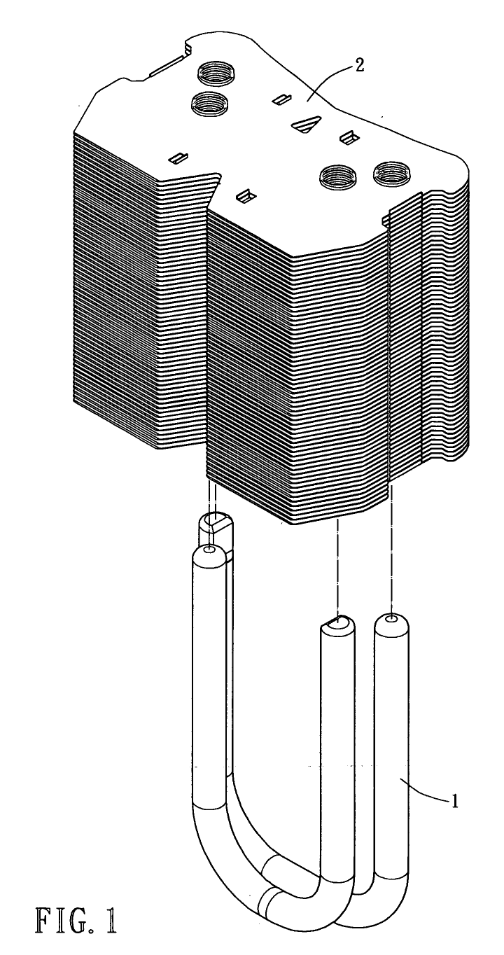

Referring to FIG. 1, an exploded view of the heat pipe and the thin fins of the present invention is illustrated. The present invention provides a method for fabricating a cooling device that includes a heat pipe 1 and a plurality of thin fins 2. The heat pipe 1 penetrates through the thin fins 2, each having a thickness of 0.2 mm, thereby providing the heat pipe 1 to dissipate heat to the environment.

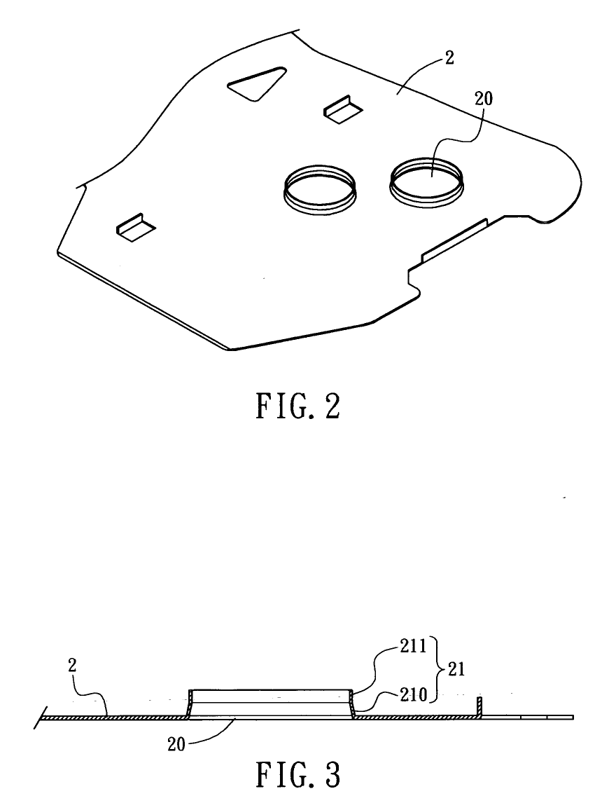

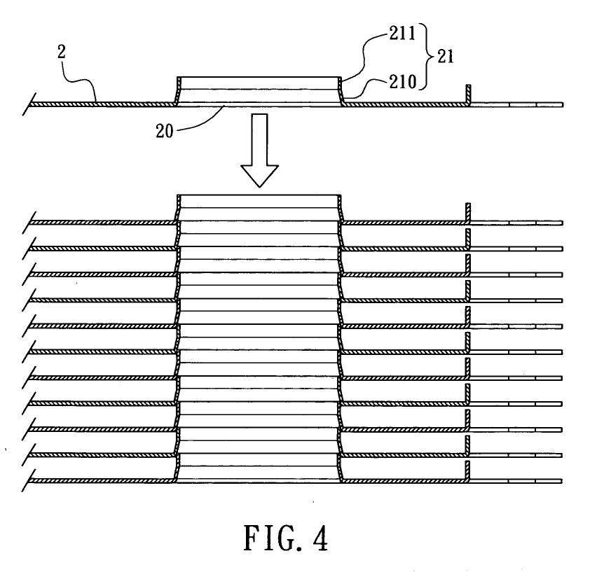

As shown in FIG. 2, FIG. 3 and FIG. 4, a plurality of through holes are punched on the thin fins 2. The number of through holes 20 formed on each thin fin 2 corresponds to how the heat pipe 1 is penetrated. When the through holes 20 of the thin fins 2 are punched, a surrounding wall 21 of shrinking radius is also pulled out from the through hole 20 (as shown in FIG. 3). The surrounding wall 21 includes a conical portion 210 formed on the edge of the through holes 20, and a compressive portion 211 extended from the conical portion 210 of smaller radius. When the thin fins 2 are stacked with each other (as shown in FIG. 4), the through hole 21 of the upper thin fin 2 is stacked on the compressive portion 211 of the lower thin fin 2.

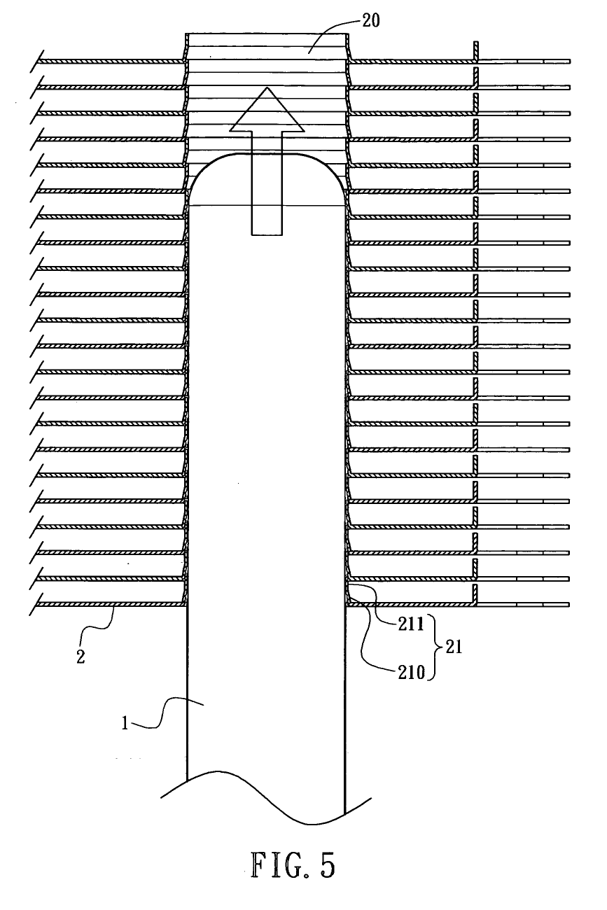

As shown in FIG. 5, the heat pipe 1 penetrates the through holes 20 of the stacked thin fins 2 from the surrounding wall 21 of larger radius. During the penetration process, the separation between the thin fins 2 will become larger. At the same time when the heat pipe 1 is penetrating the thin fins 2, a layer of heat conducting material (not shown) can be applied to the outer surface of the heat pipe 1. The heat conducting material can be any material of fine molecules and high density, such as silicon oil, mineral oil, or polyethylene glycol (PEG). The heat conducting material can also act as a lubricant, thereby easing the penetration of heat pipe 1 through the thin fins 2. Since the heat conducting material is made materials of fine molecules, it can fill in the gaps between the heat pipe and the compressive portion 211 of the thin fins. The contact between the heat pipe 1 and the thin fins 2 is thus enhanced.

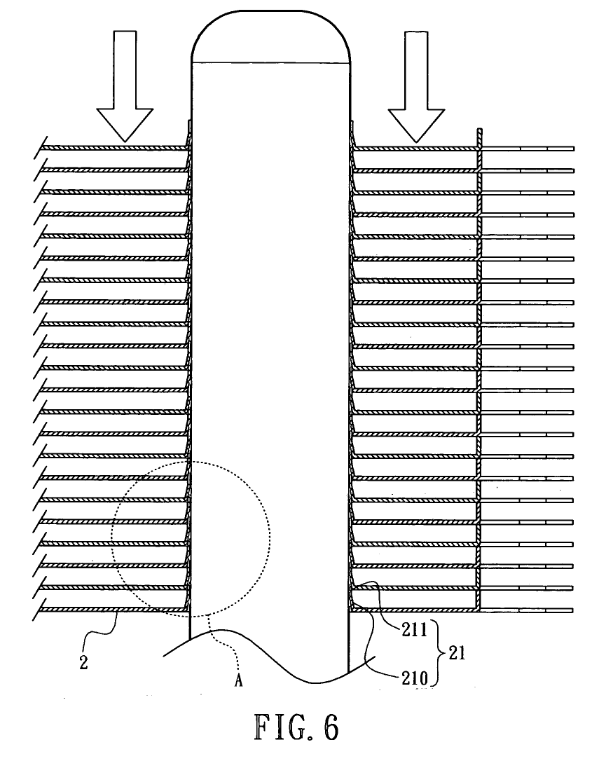

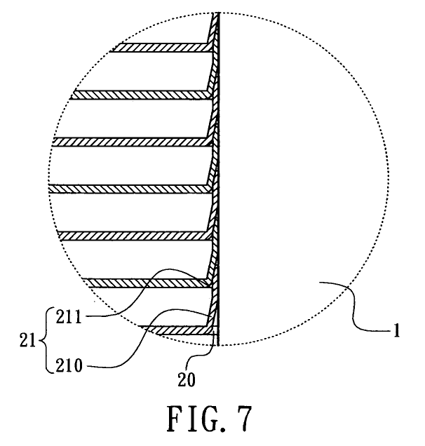

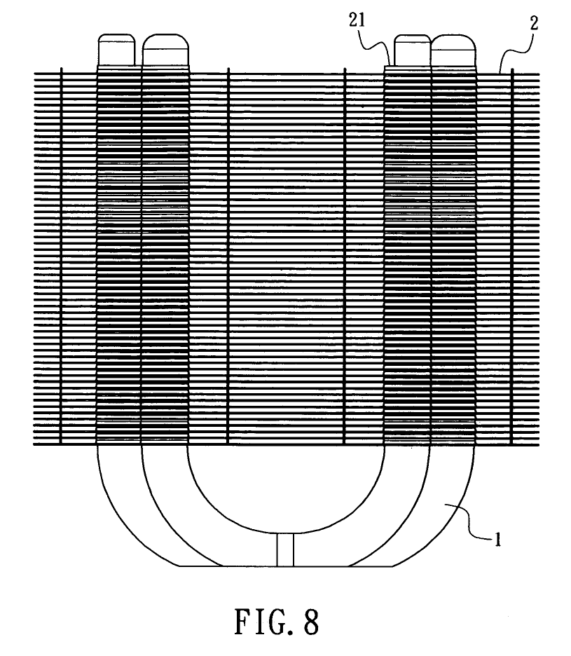

As shown in FIG. 6, two forces of opposite directions are applied to the thin fins, so as to reduce the separation between the thin fins. The compressive portion 211 of the lower thin fin 2 is embedded between the conical portion 210 of the upper thin fin 2 and the surface of the heat pipe 1 (as shown in FIG. 7). The surrounding wall 21 between the thin fins 2 can sequentially be embedded into and compressed onto the heat pipe 1. The fabrication process of the cooling device is thus completed, as shown in FIG. 8.

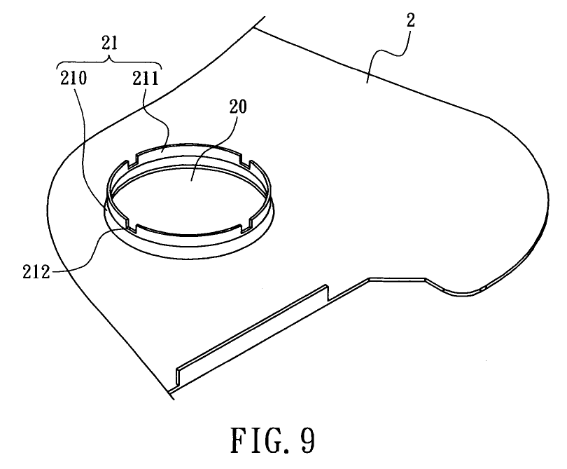

Further, as shown in FIG. 9, a plurality of notches is formed on the edge of the compressive portion 211 of the thin fins. When the compressive portion 211 of the lower thin fin 2 is embedded between the conical portion 210 of the upper thin fin 2 and the surface of the heat pipe 1, the notch will aid the deformation of the compressive portion 211. In this manner, compression strength between the conical portion 210 of the upper thin fin 2 and the surface of the heat pipe 1 is enhanced.

Following the process described above, one can fabricate the cooling device of the present invention.

As shown in FIG. 7, since the heat pipe is penetrated through the thin fins 2 of thickness smaller than 0.2 mm, the surrounding wall formed on each thin fin 2 is also of thickness smaller than 0.2 mm. After the compressive portion 211 of the surrounding wall 21 is embedded between the conical portion 210 and the surface of the heat pipe 1, the contact area between the thin fins 2 is increased. In addition, the contact strength between the surrounding wall 21 of the thin fins 2 and the heat pipe is also increased. As a result, the heat dissipating rate of the cooling device is thus enhanced.

In summary, the present invention indeed satisfies the patentability requirements of the patent law, a grant of letters patent therefor is thus respectfully requested.

Since, any person having ordinary skill in the art may readily find various equivalent alterations or modifications in light of the features as disclosed above, it is appreciated that the scope of the present invention is defined in the following claims. Therefore, all such equivalent alterations or modifications without departing from the subject matter as set forth in the following claims is considered within the spirit and scope of the present invention.

What is claimed is:

1. A method for fabricating a cooling device having a heat pipe and a plurality of thin fins, the method comprising the steps of:
forming a through hole on each thin fin, the through hole having a surrounding wall of gradually withdrawing radius, thereby stacking the thin fins together;
tightly inserting the heat pipe from the surrounding wall of larger radius into the through holes of the thin fins; and
applying two forces of opposite directions to the thin fins, thereby securely contacting the surrounding walls of the thin fins to the heat pipe.

2. The method as recited in claim 1, wherein the thickness of the surrounding wall is smaller than 0.2 mm.

3. The method as recited in claim 1, further comprises a step of applying a layer of heat conducting material on the surface of the heat pipe, the heat conducting material being a material of fine molecules and high density.

4. The method as recited in claim 3, wherein the heat conducting material is one of a silicon oil, mineral oil, and polyethylene glycol.
